(19) United States
(12) Patent Application Publication
(10) Pub. No.: US 2016/0066614 A1
(43) Pub. Date: Mar. 10, 2016

(54) UNFERMENTED BEER-FLAVOURED BEVERAGE CONTAINING INDIGESTIBLE DEXTRIN, AND BITTER SUBSTANCE

(71) Applicant: ASAHI BREWERIES, LTD., Tokyo (JP)

(72) Inventors: Shinsuke ITO, Kashiwa-shi (JP); Kyoko FUJIWARA, Tokyo (JP); Tomoko TAKAHASHI, Tokyo (JP); Takuya OHASHI, Nagareyama-shi (JP)

(73) Assignee: ASAHI BREWERIES, LTD., Tokyo (JP)

(21) Appl. No.: 14/888,857

(22) PCT Filed: Mar. 7, 2014
(86) PCT No.: PCT/JP2014/056061

§ 371 Date: Nov. 3, 2015

(30) Foreign Application Priority Data
May 29, 2013 (JP) 2013-113183

(51) Int. Cl. A23L 2/56

(52) U.S. Cl. CPC A23L 2/56; A23V 2002/00

(57) ABSTRACT

The problem of the present invention is to achieve both an enhancement of beer-like taste and an effect of suppressing an increase in blood neutral fat with respect to a non-fermented beer taste drink. The means for solving the problem is a non-fermented beer taste drink, which contains indigestible dextrin at a concentration of 8 g/L or more, and a bitter-taste substance.

### TECHNICAL FIELD

The present invention relates to a non-fermented beer taste drink, and particularly to a non-fermented alcoholic beer taste drink and a non-fermented carbonated beer taste drink.

### BACKGROUND ART

Beer taste drinks include various kinds of products such as alcoholic beer taste drinks which are alcoholic drinks substantially containing ethanol, carbonated beer taste drinks which are carbonated drinks substantially not containing ethanol, and the like.

The alcoholic beer taste drink is produced principally by fermenting a saccharified liquid of malt or cereals as a main raw material. An alcoholic beer taste drink produced through a fermentation step will be hereinafter referred to as a “fermented alcoholic beer taste drink”. On the other hand, alcoholic beer taste drinks also include those produced by adding wort, a malt extract, a saccharide, a flavor, ethanol and the like to drinking water so as to have a taste and a taste quality like beer. An alcoholic beer taste drink produced without a fermentation step will be hereinafter referred to as a “non-fermented alcoholic beer taste drink”.

The non-fermented alcoholic beer taste drink does not require a special fermentation apparatus for production because a production process does not include fermentation. Therefore, they are suitable for mass production at low costs. However, it has not been clarified yet what components and how much they are mixed to reproduce a taste and a taste quality like beer, and a production method is still under research and development.

On the other hand, carbonated beer taste drinks have a low alcohol level, and can be casually drunk by drivers and pregnant and lactating women. Generally, carbonated beer taste drinks have a low calorie in comparison with normal beer, and are thus favored by health-conscious people.

Methods for producing carbonated beer taste drinks are classified broadly into three types: (1) removal of ethanol, (2) control of fermentation and (3) non-fermentation. In method (1), only an ethanol component is removed from normal beer by a special apparatus to prepare the carbonated drink. In method (2), activity of yeasts is controlled by, for example, fermentation at a temperature lower than is normal, so that the ethanol content becomes low. A carbonated beer taste drink produced through the fermentation step will be hereinafter referred to as a “fermented carbonated beer taste drink”.

The fermented carbonated beer taste drink has a taste like beer because a production method includes a fermentation step. However, ethanol is generated in the fermentation step, and it is difficult to fully eliminate the ethanol content.

In contrast, in method (3), wort, a malt extract, a saccharide, a flavor and the like are added to drinking water to produce the carbonated drink. The carbonated beer taste drink produced without the fermentation step will be hereinafter referred to as a “non-fermented carbonated beer taste drink”. The non-fermented carbonated beer taste drink is easily made to contain no ethanol because a production process does not include fermentation. Further, no special fermentation apparatus is required for production. Therefore, such drinks are suitable for mass production at low costs, and are low-price drinks suiting all tastes. However, it has not been clarified yet what components and in what amounts they can be mixed to reproduce a taste and a taste quality like beer, and a production method is still under research and development.

The non-fermented alcoholic beer taste drink can be produced by adding a predetermined amount of ethanol in a process of producing a non-fermented carbonated beer taste drink. In other words, an essential difference between the former and the latter lies only in whether ethanol is contained or not. Therefore, in the present description, the non-fermented alcoholic beer taste drink and the non-fermented carbonated beer taste drink are dealt with together, and both the drinks are collectively referred to as a “non-fermented beer taste drink”.

Patent Document 1 describes that in a step of producing a non-fermented carbonated beer taste drink, use of a vegetable protein decomposition product and a malt extract as raw materials can impart beer-like bitterness and a rich taste (body), so that profoundness and coordination can be added to a flavor. However, the malt extract itself has a strong sweet taste and umami taste. Therefore, if the malt extract is contained in the non-fermented beer taste drink, an excessive sweet taste and umami taste stand out. This makes it difficult to adjust the balance of taste, and moreover an unfavorable smell of malt itself stands out.

As a result, conventional non-fermented beer taste drinks are greatly different from usual beer in terms of beer-like taste. In particular, they are inferior to usual beer in “good balance”, “drink fulfillment and stimulation to a throat” and “satisfactory sharpness after drinking”.

Patent Document 1 discloses a non-fermented carbonated beer taste drink containing polydextrose as a specific example. However, Patent Document 1 does not describe the purpose of use, function and effect of polydextrose. Therefore, polydextrose is merely described as a component, and there is no description to the effect that polydextrose solves the above problems.

On the other hand, in the field of fermented alcoholic beer taste drinks, methods for enhancing drink fulfillment and satisfactory sharpness after drinking are known. For example, Patent Document 2 describes that drink fulfillment can be secured by increasing the use ratio of malt in a raw material, and that the sharp feeling of the drink going down the throat can be imparted without impairing drink fulfillment of a malt-fermented drink by adding a distilled liquid obtained by distilling an alcohol-containing substance with wheat as one of raw materials.

Further, an excessive fat intake accompanied by westernization of recent Japanese diet is said to increase a risk of developing not only obesity and metabolic syndrome, but also lifestyle diseases such as hyper lipidemia and arterial sclerosis, which are considered as a problem since they are causes of bringing serious effects on the nation's health. A fasting blood neutral fat level is one of diagnostic criteria of metabolic syndrome. Reducing this level is effective for obesity prevention. On the other hand, recently, hyperlipidemia after a meal, in which high neutral fat levels in the blood continue for a long time, is also drawing attention. It is becoming apparent that hyperlipidemia after a meal is a risk factor of cardiovascular diseases and cerebral infarction. That is, suppressing an increase in blood neutral fat after a meal is considered to be effective for prevention of not only obesity but also cardiovascular diseases and cerebral sclerosis.

As a food material having an effect of suppressing an increase in blood neutral fat, indigestible dextrin that is a water-soluble dietary fiber has been reported. As its mechanism, the following has become apparent: Indigestible dextrin inhibits degradation of bile acid micelles to stabilize them, and lipid absorption is inhibited by delayed lipid release. Also, it promotes fecal excretion of lipids. Since indigestible dextrin has excellent processing suitability and stability, it has hitherto been used for various foods. Thus it is an excellent food material also from the viewpoint of safety.

Patent Documents 3-5 disclose that indigestible dextrin is contained in brewing raw materials. However, the purpose of the use of indigestible dextrin is to achieve low calorie beer in Patent Document 3. In Patent Documents 4 and 5, it is to impart a flavor and a rich taste, not to impart a “good balance”, “drink fulfillment and stimulation to a throat” and “satisfactory sharpness after drinking”. Furthermore, there is no description of the effect of suppressing an increase in blood neutral fat at all.

In the first place, in the fermented alcoholic beer taste drink, a low-molecular-weight saccharide and a nitrogen source are consumed by yeast, and it is scarcely contained in a final product. Therefore, the fermented alcoholic beer taste drink per se essentially has a “good balance”, “drink fulfillment and stimulation to a throat” and “satisfactory sharpness after drinking” and thus they do not exist as the problems to be solved.

### PRIOR ART DOCUMENTS

### Patent Document 1 JP 2011-142901 A

### Patent Document 2 WO 2005/056746 A1

### Patent Document 3 JP H08-009953 A

### Patent Document 4 JP H08-000249 A

### Patent Document 5 JP 2006-006342 A

### SUMMARY OF THE INVENTION

### Problems to be Solved by the Invention

The present invention solves the above-mentioned conventional problems, and an object thereof is to impart a taste like beer and an effect of suppressing an increase in blood neutral fat to a non-fermented beer taste drink. More specifically, it is to suppress an increase in blood neutral fat, while imparting a taste like beer to a non-fermented beer taste drink by enhancing and appropriately balancing “drink fulfillment and stimulation to a throat” and “satisfactory sharpness after drinking” in the non-fermented beer taste drink. That is, the problems to be solved by the invention are to achieve both an enhancement of beer-like taste and an effect of suppressing an increase in blood neutral fat with respect to a non-fermented beer taste drink.

### Means for Solving the Problems

The present invention provides a non-fermented beer taste drink, which contains indigestible dextrin at a concentration of 8 g/L or more, and a bitter-taste substance.

In one embodiment, the bitter-taste substances are iso-α-acids.

One embodiment of the non-fermented beer taste drink has a concentration of the iso-α-acids of 0.001 g/L or more.

One embodiment of the non-fermented beer taste drink was produced without using wort or a barley extract.

One embodiment of the non-fermented alcoholic beer taste drink further contains a sweet-taste substance.

One embodiment of the non-fermented beer taste drink has a concentration of the sweet-taste substance of 18 g/L or less in sucrose equivalent.

In one embodiment, the sweet-taste substance is acesulfame K, and its concentration is 0.09 g/L or less.

In one embodiment, the sweet-taste substance is at least one saccharide selected from the group consisting of a monosaccharide, a disaccharide, and a trisaccharide.

One embodiment of the non-fermented beer taste drink has an effect of reducing blood neutral fat by drinking.

### Effect of the Invention

The non-fermented beer taste drink of the present invention has enhanced and appropriately balanced “drink fulfillment and stimulation to a throat” and “satisfactory sharpness after drinking”, and, while having a beer-like taste, it also has an effect of suppressing an increase in blood neutral fat.

### BRIEF DESCRIPTION OF THE DRAWING

FIG. 1 is a graph showing how blood neutral fat levels fluctuate after subjects with slightly high blood neutral fat levels were allowed to take the non-fermented beer taste drink of the present invention together with a loaded meal (a: measurements, b: changes in levels).

### DESCRIPTION OF EMBODIMENTS

The non-fermented beer taste drink of the present invention contains indigestible dextrin. By containing indigestible dextrin, the resulting beer gives a sensation of striking a throat when drunk. That is, by the present invention, the non-fermented beer taste drink having the characteristics of fermented beer taste drinks, i.e., a “good balance”, “drink fulfillment and stimulation to a throat” and “satisfactory sharpness after drinking”, is provided.

Indigestible dextrin has an effect of suppressing an increase in blood neutral fat after a meal and thus the non-fermented beer taste drink of the present invention is effective for prevention of obesity, cardiovascular diseases, cerebral sclerosis and the like. Since there is a tendency that beer taste drinks are taken with a high lipid diet (high fat food), it is highly significant that a function of suppressing an increase in blood neutral fat after a meal is imparted to the beer taste drink.

Indigestible dextrin is a decomposition product of starch, which is obtained by allowing an enzyme such as α-amylase to act on dextrin obtained by acid roasting starch.

The amount of the indigestible dextrin contained in the non-fermented beer taste drink according to the present invention is 8 g/L or more in terms of concentration. If the concentration of the indigestible dextrin is less than 8 g/L, the sensation of striking the throat in the non-fermented beer taste drink becomes weak. Also, the effect of suppressing an increase in blood neutral fat becomes weak. The concentration of the indigestible dextrin is preferably 9 to 25 g/L, more preferably 12.8 to 16.2 g/L. If the concentration of the indigestible dextrin is more than 25 g/L, the taste of the non-fermented beer taste drink may be degraded.

It is preferred that the non-fermented beer taste drink according to the present invention suitably contains a sweet-taste substance. The sweet-taste substance refers to a substance causing a person to feel a sweet taste when it is held in his or her mouth. A typical sweet-taste substance is a sweetener. The sweetener refers to a seasoning that is used for adding a sweet taste to drinks or foods. By containing the sweet-taste substance, the resulting drink is well balanced between a sour taste and a sweet taste, and becomes hard to give an aftertaste of the sour taste, the sweet taste or the like, so that “satisfactory sharpness after drinking” is exhibited.

Examples of the sweet-taste substance include saccharides or sugar alcohols, and high intensity sweeteners. Examples of the saccharide include glucose, fructose, wood sugar, sorbose, galactose, isomerized sugars (fructose-glucose syrup, glucose-fructose syrup, high-fructose syrup, etc.), sucrose, maltose, lactose, isomerized lactoses, palatinose, isomaltose, maltotriose, raffinose, fructo-oligosaccharides, malto-oligosaccharides, isomalto-oligosaccharides, galacto-oligosaccharides, coupling sugars, palatinose and the like. Examples of the sugar alcohol include erythritol, sorbitol, xylitol, mannitol, maltitol, isomaltitol, lactitol, maltotriitol, isomaltotriitol, panitol and the like. Examples of the high intensity sweeteners include aspartame, stevia, enzyme-treated stevia, thaumatin, sucralose, acesulfame K, neotame, Momordica grosvenori, and the like.

In one embodiment, a low-molecular-weight saccharide is used as the sweet-taste substance. The low-molecular-weight saccharide refers to an oligomer with various kinds of saccharides linked by a glycoside linkage. A more preferable sweet-taste substance is one or more selected from the group consisting of a monosaccharide, a disaccharide and a trisaccharide. A further preferable sweet-taste substance is one or more selected from the group consisting of glucose, fructose, maltose, fructose-glucose and glucose-fructose.

The concentration of the sweet-taste substance contained in the non-fermented beer taste drink is appropriately adjusted within a range not exceeding 18 g/L in terms of sucrose.

The sweet-taste substance in the present invention is preferably acesulfame K. In this case, the amount of acesulfame K contained in the non-fermented beer taste drink is 0.09 g/L or less, preferably 0.015 to 0.060 g/L, and more preferably 0.015 to 0.045 g/L in terms of concentration.

For example, the content of the sweet-taste substance is adjusted in consideration of the amount of ethanol contained in the non-fermented beer taste drink. This is because ethanol also has a sweet taste as a taste exhibiting function. The form of ethanol added is not limited, and for example, material alcohol, beer, shochu, awamori, whisky, brandy, vodka, rum, tequila, gin, spirits and so on can be added.

When the non-fermented beer taste drink is a non-fermented beer taste carbonated drink which substantially does not contain ethanol, the concentration of the sweet-taste substance contained in the non-fermented beer taste drink is 18 g/L or less, preferably 3 to 12 g/L, and more preferably 3 to 9 g/L in sucrose equivalent.

When the non-fermented beer taste drink is a non-fermented alcoholic beer taste drink which substantially contains ethanol, the concentration of the sweet-taste substance contained in the non-fermented beer taste drink is 0.1 to 1.8 g/L, preferably 0.4 to 1.3 g/L, and more preferably 0.6 to 1.1 g/L in sucrose equivalent.

The non-fermented beer taste drink according to the present invention preferably contains a cereal-derived protein decomposition product. By containing the cereal-derived protein decomposition product, the sensation of striking the throat when the non-fermented beer taste drink is drunk, namely “drink fulfillment and stimulation to a throat” is further enhanced. Further, the cereal-derived protein decomposition product also has a foam-retaining function.

The cereal-derived protein decomposition product is a product obtained by hydrolyzing a cereal protein raw material by an acid, an alkali or an enzyme, wherein the cereal protein raw material is a vegetable protein raw material which is a fraction obtained from soybean, pea, corn, wheat, barley, rice, peanut, rapeseed, sunflower and the like and contains a protein such as a separated protein in a large amount. The cereal-derived protein raw material is preferably a protein derived from legume such as soybean and pea, and the hydrolysis method is preferably an enzymic method. The enzymic method uses one or more proteases to carry out hydrolysis using their suitable temperature, pH and time. The degree of decomposition can be appropriately adjusted, but generally a 15 wt % TCA solubilization rate of 30 to 100% is suitable. If the molecule size is too large, a large amount of fraction is insolubilized in the form of sediments in a post-process or during storage, and if the molecule size is too small, a discomfort umami taste is easily caused. Accordingly, a suitable average molecular weight of a water-soluble fraction contained in the cereal-derived protein decomposition product is 550 or more and 3,000 or less, preferably 600 or more and 1,500 or less.

The meanings of the 15 wt % TCA solubilization rate and average molecular weight of a water-soluble fraction that are parameters of the cereal-derived protein decomposition product are as described, respectively, in paragraphs [0017] and [0018] of Patent Document 1.

If the amount of the cereal-derived protein decomposition product contained in the non-fermented beer taste drink according to the present invention is too small, its effect is low, and if the amount is too large, conversely an unpleasant taste is easily caused, and further a risk of microbiological contamination may be caused due to a rise in pH. Generally, the cereal-derived protein decomposition product is used in such an amount that the concentration in the final drink is 10 g/L or less, preferably 0.1 to 6 g/L, more preferably 0.5 to 4 g/L.

Preferably, the non-fermented beer taste drink according to the present invention does not contain wort or a barley extract. The wort refers to a liquid obtained by crushing and saccharifying barley malt. The barley extract refers to a liquid extract of a component extracted from barley, barley malt or a crushed product thereof with water or hot water, or a concentrated product or a dried product of the extract liquid. The wort or barley extract contains a relatively low-molecular-weight saccharide or nitrogen source in a large amount, and has a strong sweet taste or umami taste as such. Therefore, if the wort or barley extract is included in the non-fermented beer taste drink, tastes are hard to be balanced, so that a sweet taste remains as an aftertaste and an unpleasant odor is easily generated.

Preferably, the non-fermented beer taste drink according to the present invention is produced without using wort or a barley extract. “Using wort or a barley extract” means that wort or a barley extract is mixed with the non-fermented beer taste drink in a substantial amount as wort or a barley extract. For example, when wort or a barley extract is contained in a flavor, and the wort or barley extract is mixed in a small amount with the non-fermented beer taste drink as the flavor, such a case does not fall under the production with the use of the wort or barley extract.

The wort refers to a liquid obtained by crushing and saccharifying barley malt. Malt saccharified liquid is obtained, for example, by saccharification reaction of barley malt using a malt derived enzyme. The malt saccharified liquid may also be obtained by saccharification reaction of barley with a malt derived enzyme. The barley extract refers to a liquid extract of a component extracted from barley, barley malt or a crushed product thereof with water or hot water, or a concentrated product or a dried product of the extract liquid. The wort or barley extract contains a relatively low-molecular-weight saccharide or nitrogen source in a large amount, and has a strong sweet taste or umami taste as such. Therefore, if the wort or barley extract is used in the non-fermented beer taste drink, tastes are hard to be balanced, so that a sweet taste remains as an aftertaste and an unpleasant odor is easily generated.

However, if the good balance, and satisfactory sharpness after drinking” are not impaired, the non-fermented beer taste drink of the present invention may be produced using wort or a barley extract.

The content of wort or a barley extract in the non-fermented beer taste drink of the present invention is such that the concentration of a non-volatile component of wort or a barley extract is 2 wt % or less, preferably 1 wt % or less, and more preferably 0.5 wt % or less.

Essentially, in a yeast-fermented beer taste drink, a low-molecular-weight saccharide or nitrogen source is consumed by the yeast, and hardly contained in the final product. In contrast, a high-molecular-weight saccharide is not consumed by the yeast, and therefore remains as it is in the final product. It is believed that in the fermented beer taste drink, balance of contents between only a small amount of a low-molecular-weight saccharide (sweet-taste substance) and a large amount of a high-molecular-weight saccharide suppresses an excessive aftertaste such as an excessive sweet taste or umami taste to provide drink fulfillment and stimulation to a throat, so that a taste like beer is realized.

The non-fermented beer taste drink according to the present invention contains a bitter-taste substance in order to reproduce a refreshing bitter taste peculiar to beer. The bitter-taste substance refers to a substance causing a person to feel a bitter taste when it is held in his or her mouth. By containing the bitter-taste substance, the resulting drink hardly imparts stickiness due to addition of indigestible dextrin, and a heavy aftertaste, so that “satisfactory sharpness after drinking” is exhibited. The bitter-taste substance is not particularly limited as long as it exhibits a bitter taste similar or close to beer. It may be a bitter-taste substance contained in hops, and it may also be a bitter-taste substance not contained in hops. Specific examples of the bitter-taste substance include bitter-taste imparting components such as a magnesium salt, calcium salt, tributyl citrate, triethyl citrate, naringin, quassin, iso-α-acids, tetra-iso-α-acids, oxidation product of β-acids, quinine, momordicin, quercitrin, theobromine, and caffeine, bitter-taste imparting materials such as bitter gourd, Swertia herb tea, Ku Ding tea, wormwood extract, gentian extract, and quinine extract. Particularly, iso-α-acids are preferred because they can suppress stickiness due to addition of indigestible dextrin and can impart a more beer-like taste.

Isolated iso-α-acids can be used. Iso-α-acids are contained in hops and thus can also be used as hops or a hop extract. The hops or hop extract refers to leaves of hops, their ground products, an extract liquid obtained by extracting them with water or hot water, a concentrated product of the extract liquid and a dried product thereof.

The amount of iso-α-acids contained in the non-fermented beer taste drink of the present invention is 0.001 g/L or more in terms of concentration. If the concentration of iso-α-acids is less than 0.001 g/L, an aftertaste of the non-fermented beer taste drink containing indigestible dextrin is sticky and heavy. Preferably, the concentration of iso-α-acids is 0.005 to 0.08 g/L, and more preferably 0.01 to 0.03 g/L. If the concentration of iso-α-acids is more than 0.08 g/L, the taste of the non-fermented beer taste drink may deteriorate.

In addition to that, the non-fermented beer taste drink of the present invention may be used in combination with raw materials such as saccharides, various glycosides such as a sugar alcohol, and saponin, a flavor, dietary fiber, a polysaccharide, acids, and a yeast extract within the scope not impairing the object of the present invention. Examples of the saccharides include reducing sugars such as glucose, fructose and maltose, oligosaccharides such as sucrose, and various kinds of dextrins and oligosaccharides, and examples of the flavor may include a malt flavor (which may contain a natural extract derived from wheat or malt), a hop flavor (which may contain a natural extract derived from hops), a beer flavor, an alcohol flavor, a caramel flavor and the like. Examples of the acids may include organic acids such as citric acid, lactic acid and tartaric acid, and mineral acids such as hydrochloric acid and phosphoric acid.

A method for production of a non-fermented beer taste drink according to the present invention includes steps that are normally carried out when a non-fermented beer taste drink is produced. As one example, a polymeric saccharide, a sweet-taste substance and other components are first mixed in predetermined amounts to prepare a formulation. Then, to the formulation is added drinking water in a predetermined amount to prepare a primary raw material liquid. The primary raw material liquid is boiled, a fermented alcohol is then added as necessary, and carbonic acid is added by a carbonation step.

It is also possible to separate and remove precipitates by filtration, centrifugal separation or the like in each stage as necessary. Also, carbonated water may be added after the raw material liquid is prepared in a concentrated state. In these steps, a non-fermented beer taste drink can be conveniently prepared by using a normal process for production of a soft drink without necessity of fermentation equipment.

Removal of precipitates before the carbonation step and the carbonated water adding step is desirable because sediments and substances causing an unpleasant taste can be removed. Filtration or sterilization may be performed as necessary before the carbonation step and the carbonated water adding step.

### EXAMPLES

The present invention will be described more specifically with reference to the following examples, but the present invention is not limited thereto.

### Comparative Example 1

### Formulation of Indigestible Dextrin

Formulation ingredients (unit: g) listed in Table 1 were mixed, and the mixture was filled with water measured to have a volume of 1 L using a measuring flask. The mixture was boiled for one hour and then water corresponding to an evaporated amount of water was added. Diatomite filtration and filter filtration were performed for clarification. A carbon dioxide gas was then blown into the liquid, so that the carbon dioxide gas was dissolved in a gas volume of 2.9.

TABLE 1

| | Control | Experimental | Experimental | Experimental |
|---|---|---|---|---|
| | plot 1 | plot 1 | plot 2 | plot 3 |
| Indigestible | 0.0 | 9.0 | 12.8 | 16.2 |
| dextrin | (0.0) | (10.0) | (14.2) | (18.0) |
| (Fibersol-2) | | | | |
| Soybean | 2.0 | 2.0 | 2.0 | 2.0 |
| protein | | | | |
| decomposition | | | | |
| product | | | | |
| Caramel | 0.3 | 0.3 | 0.3 | 0.3 |
| Phosphoric | 0.7 | 0.7 | 0.7 | 0.7 |
| acid | | | | |

As indigestible dextrin, “Fibersol-2” (trade name) manufactured by Matsutani Chemical Industry Co., Ltd. was used (data hereinbelow are also the same). The content of indigestible dextrin in Fibersol-2 was 90 wt %. A soybean protein decomposition product, caramel, and phosphoric acid were mixed for the purposes of imparting drink fulfillment and retaining foam, coloring, and adjusting pH values, respectively.

The evaluation of the obtained drinks was shown in Table 2. For the evaluation, scores on a scale of 9 marked by 5 beer expert panelists, respectively, were averaged. A sensory evaluation was conducted with a nose clip attached to the nose in order to avoid influences by an aroma. Compared to a control plot containing no indigestible dextrin, all Experimental plots received low ratings for “good balance”, and “satisfactory sharpness after drinking”. Also in comments, ratings such as sticky, heavy, a remaining aftertaste, which are unfavorable as beer, were found. In particular, Experimental plots 2 and 3, in which 12.8 g/L or more of indigestible dextrin was added, were unpalatable due to a thick, sticky poor taste, so that there was observed a tendency that the property that satisfactory sharpness after drinking as beer taste was impaired.

TABLE 2

| | Control | Experimental | Experimental | Experimental |
|---|---|---|---|---|
| | plot 1 | plot 1 | plot 2 | plot 3 |
| Good | 4.8 | 4.8 | 3.4 | 3.2 |
| balance | | | | |
| Sharpness | 5.0 | 4.0 | 2.0 | 2.0 |
| after | | | | |
| drinking | | | | |
| Comments | Refreshing, | With an | Sticky, thick, | Sticky, thick, |
| | weak, | accent, sticky, | heavy, a sense | heavy, |
| | watery, | a sensation of | of body, sour | a sense |
| | light, sour | striking a | taste | of body, a |
| | taste | throat, a sense | | remaining |
| | | of body, sour | | aftertaste, |
| | | taste | | sour taste |

### Example 1

### Formulation of Iso-α-Acids

With respect to Experimental plot 2 which received low ratings in the comparative example, iso-α-acids derived from hops were added in order to improve a thick, sticky poor taste. The iso-α-acids were added in the form of hops (Table 3) and a “bittering agent” (Table 4) respectively, and the amounts added were adjusted so as to conform to the amount of the iso-α-acids. Formulation ingredients (unit: g) listed in Tables 3, 4 were mixed, and the mixture was filled with water measured to have a volume of 1 L using a measuring flask. The mixture was boiled for one hour and then water corresponding to an evaporated amount of water was added. Diatomite filtration and filter filtration were carried out for clarification. A carbon dioxide gas was then blown into the liquid, so that the carbon dioxide gas was dissolved in a gas volume of 2.9.

TABLE 3

| | | | Experi- | | Experi- |
|---|---|---|---|---|---|
| | Control | Experimental | mental | Experimental | mental |
| | plot 2 | plot 4 | plot 5 | plot 6 | plot 7 |
| Indigestible | 12.8 | 12.8 | 12.8 | 12.8 | 12.8 |
| dextrin | (14.2) | (14.2) | (14.2) | (14.0) | (14.2) |
| (Fibersol-2) | | | | | |
| Soybean | 2.0 | 2.0 | 2.0 | 2.0 | 2.0 |
| protein | | | | | |
| decomposition | | | | | |
| product | | | | | |
| Caramel | 0.3 | 0.3 | 0.3 | 0.3 | 0.3 |
| Phosphoric | 0.7 | 0.7 | 0.7 | 0.7 | 0.7 |
| acid | | | | | |
| Hops (iso-α- | 0.00 | 0.01 | 0.02 | 0.03 | 0.04 |
| acids) | | | | | |

Using “CO₂ Hop Extract” (trade name) manufactured by Barth-Haas Group as hops, an adjustment was made so that the iso-α-acids content (g/L) was as described in the table.

TABLE 4

| | Experimental | Experimental | Experimental | Experimental |
|---|---|---|---|---|
| | plot 8 | plot 9 | plot 10 | plot 11 |
| Indigestible | 12.8 | 12.8 | 12.8 | 12.8 |
| dextrin | (14.2) | (14.2) | (14.2) | (14.2) |
| (Fibersol-2) | | | | |
| Soybean | 2.0 | 2.0 | 2.0 | 2.0 |
| protein | | | | |
| decomposition | | | | |
| product | | | | |
| Caramel | 0.3 | 0.3 | 0.3 | 0.3 |
| Phosphoric | 0.7 | 0.7 | 0.7 | 0.7 |
| acid | | | | |
| Bittering agent | 0.01 | 0.02 | 0.03 | 0.04 |
| (iso-α-acids) | | | | |

Using “ISOHOP” (trade name) manufactured by Barth-Haas Group as hops, an adjustment was made so that the iso-α-acids content (g/L) was as described in the table.

The evaluation of the obtained drinks was shown in Table 5. For the evaluation, scores on a scale of 9 marked by 3 beer expert panelists, respectively, were averaged. A sensory evaluation was conducted with a nose clip attached to the nose in order to avoid influences by an aroma. Compared to a control plot, Experimental plots in which the iso-α-acids were added in the form of hops, and Experimental plots in which the iso-α-acids were added in the form of the bittering agent both received higher ratings for “good balance” and “satisfactory sharpness after drinking” at the final iso-α-acids content of 0.01 to 0.03 g/L, in particular, the rating was the highest at 0.02 g/L. Comments such as sticky, heavy, a remaining aftertaste became less noticeable, whereas a sour taste was noticeable in the top to the middle taste. Therefore, the whole balance did not seem to be maintained.

TABLE 5

| | | Experimental | Experimental | Experimental | Experimental |
|---|---|---|---|---|---|
| | Control plot 2 | plot 4 | plot 5 | plot 6 | plot 7 |
| Good | 3.7 | 4.7 | 5.7 | 4.3 | 1.7 |
| balance | | | | | |
| Satisfactory | 2.3 | 5.0 | 6.0 | 5.3 | 1.7 |
| sharpness | | | | | |
| after | | | | | |
| drinking | | | | | |
| Comments | Sticky, | Sticky, | Satisfactory | Rough bitter | A remaining |
| | weak, | weak, sour | sharpness, | taste, a | bitter taste, |
| | heavy, | taste | rough bitter | remaining | poor |
| | watery, | | taste, with | bitter taste, | balance, |
| | thick, sour | | an accent, | with an | strong bitter |
| | taste | | sour taste in | accent, sour | taste, rough |
| | | | the first half, | taste in the | bitter taste |
| | | | a remaining | first half | |
| | | | bitter taste | | |

| | Experimental | | Experimental | Experimental |
|---|---|---|---|---|
| | plot 8 | Experimental plot 9 | plot 10 | plot 11 |
| Good balance | 4.7 | 5.7 | 4.0 | 1.7 |
| Satisfactory | 4.7 | 5.7 | 5.0 | 1.7 |
| sharpness | | | | |
| after drinking | | | | |
| Comments | Sticky, with a | Poignant, with | Poignant, with | A remaining |
| | little accent, | an accent, | an accent, | bitter taste, |
| | sour taste | sour taste in | rough bitter | poor balance, a |
| | | the first half, a | taste, sour | strong bitter |
| | | remaining | taste in the | taste, a rough |
| | | bitter taste | first half, a | bitter taste |
| | | | remaining | |
| | | | bitter taste | |

### Example 2

### Formulation of Sweet-Taste Substance

Formulation ingredients (unit: g) listed in Table 6 were mixed, and the mixture was filled with water measured to have a volume of 1 L using a measuring flask. The mixture was boiled for one hour and water was then added in an amount equal to the amount of evaporated water. Diatomite filtration and filter filtration were performed for clarification. A carbon dioxide gas was then blown into the liquid, so that the carbon dioxide gas was dissolved in a gas volume of 2.9.

TABLE 6

| | Control plot 3 | Experimental plot 12 |
|---|---|---|
| Indigestible dextrin | 12.8 | 12.8 |
| (Fibersol-2) | (14.2) | (14.2) |
| Sweet-taste substance | 0 | Various saccharides listed |
| | | in Table 7, sweeteners |
| Soybean protein | 2.0 | 2.0 |
| decomposition product | | |
| Caramel | 0.3 | 0.3 |
| Phosphoric acid | 0.7 | 0.7 |
| Hops | 0.02 | 0.02 |

As the sweet-taste substance, glucose, maltose, fructose-glucose, acesulfame K, sucralose, stevia, aspartame, and thaumatin were respectively mixed after adjusting degrees of their sweetness. The concentration of the sweet-taste substances is 5 g/L in sucrose equivalent. Using “CO₂ Hop Extract” (trade name) manufactured by Barth-Haas Group as hops, an adjustment was made so that the iso-α-acids content (g/L) was 0.02 g/L.

The evaluation of the obtained drinks was shown in Table 7. For the evaluation, scores on a scale of 9 marked by 3 beer expert panelists, respectively, were averaged. A sensory evaluation was conducted with a nose clip attached to the nose in order to avoid influences by an aroma. Compared to a control plot, it was confirmed that Experimental plots received higher ratings for “good balance” and “satisfactory sharpness after drinking” with a monosaccharide, disaccharides and acesulfame K of the Experimental plots. Also, the energies of samples using these low-molecular-weight saccharides and sweeteners were checked. Those samples using the sweeteners including acesulfame K had a very low amount of energy, so that it was confirmed that these formulations could reduce energy intake of those who were concerned with obesity and metabolic syndrome.

TABLE 7

| | | Satisfactory | | |
|---|---|---|---|---|
| | Good | sharpness after | | Energy |
| | balance | drinking | Comments | (kcal/100 mL) |
| Control plot 3 | 5.0 | 5.7 | Sour taste, a | 3.0 |
| | | | remaining bitter | |
| | | | taste, watery, poor | |
| | | | balance, a | |
| | | | remaining bitter | |
| | | | taste | |
| Experimental plot | 6.7 | 6.7 | Sticky sweet | 6.2 |
| 12-1 | | | taste, good | |
| Glucose 8.0 g | | | balance | |
| Experimental plot | 6.7 | 6.3 | Thick, sticky, good | 7.8 |
| 12-2 | | | balance | |
| Maltose 12.0 g | | | | |
| Experimental plot | 7.7 | 7.3 | Good balance, | 5.4 |
| 12-3 | | | satisfactory | |
| Fructose glucose | | | sharpness, | |
| 6.0 g | | | harmonious | |
| Experimental plot | 7.0 | 6.7 | Satisfactory | 3.0 |
| 12-4 | | | sharpness, a little | |
| Acesulfame K 0.025 g | | | sour taste, a little | |
| | | | watery, good | |
| | | | balance | |
| Experimental plot | 5.3 | 4.3 | Sweet taste | 3.0 |
| 12-5 | | | coming later, sour | |
| Sucralose 0.008 g | | | taste in the first | |
| | | | half, with a sense | |
| | | | of discomfort | |
| Experimental plot | 4.7 | 3.7 | Sweet taste | 3.0 |
| 12-6 | | | coming later, with | |
| Stevia 0.02 g | | | a sense of | |
| | | | discomfort, | |
| | | | poignant, | |
| | | | inharmonious | |
| Experimental plot | 5.0 | 4.0 | A remaining sweet | 3.0 |
| 12-7 | | | taste, with a sense | |
| Aspartame 0.025 g | | | of discomfort, sour | |
| | | | taste in the first | |
| | | | half, inharmonious | |
| Experimental plot | 3.7 | 2.3 | Sweet taste | 3.0 |
| 12-8 | | | coming later, with | |
| Thaumatin 0.002 g | | | a sense of | |
| | | | discomfort, | |
| | | | inharmonious | |

Formulation of Acesulfame K

Formulation ingredients listed in Table 8 were mixed, and the mixture was filled with water measured to have a volume of 1 L using a measuring flask. The mixture was boiled for one hour and water was then added in an amount equal to the amount of evaporated water. Diatomite filtration and filter filtration were performed for clarification. A carbon dioxide gas was then blown into the liquid, so that the carbon dioxide gas was dissolved in a gas volume of 2.9.

TABLE 8

| | | | Experi- | | Experi- |
|---|---|---|---|---|---|
| | Control | Experimental | mental | Experimental | mental |
| | plot 4 | plot 13 | plot 14 | plot 15 | plot 16 |
| Indigestible | 12.8 | 12.8 | 12.8 | 12.8 | 12.8 |
| dextrin | (14.2) | (14.2) | (14.2) | (14.2) | (14.2) |
| (Fibersol-2) | | | | | |
| Acesulfame K | 0.000 | 0.015 | 0.030 | 0.045 | 0.060 |
| Soybean | 2.0 | 2.0 | 2.0 | 2.0 | 2.0 |
| protein | | | | | |
| decomposition | | | | | |
| product | | | | | |
| Caramel | 0.3 | 0.3 | 0.3 | 0.3 | 0.3 |
| Phosphoric | 0.7 | 0.7 | 0.7 | 0.7 | 0.7 |
| acid | | | | | |
| Hops | 0.02 | 0.02 | 0.02 | 0.02 | 0.02 |

Using “CO₂ Hop Extract” (trade name) manufactured by Barth-Haas Group as hops, an adjustment was made so that the iso-α-acids content (g/L) was 0.02 g/L.

The evaluation of the obtained drinks was shown in Table 9. As for the evaluation, ratings by a panel of 5 experts, each on a scale of 9, were averaged. Experimental plots received higher ratings for “good balance” and “satisfactory sharpness after drinking” with the addition of acesulfame K in an amount of 0.015 to 0.045 g/L, in particular, rating was the highest in an amount of 0.030 g/L.

TABLE 9

| | | Experimental | Experimental | Experimental | Experimental |
|---|---|---|---|---|---|
| | Control plot 4 | plot 13 | plot 14 | plot 15 | plot 16 |
| Good | 5.2 | 6.8 | 7.4 | 6.4 | 4.2 |
| balance | | | | | |
| Satisfactory | 5.6 | 6.6 | 7.2 | 6.2 | 4.8 |
| sharpness | | | | | |
| after | | | | | |
| drinking | | | | | |
| Comments | Watery, | Satisfactory | Satisfactory | With an | Strong |
| | sour | sharpness, | sharpness, | accent, good | sweet taste, |
| | taste, | good | with an | balance, | poor |
| | noticeable | balance, | accent, good | drink | balance, |
| | bitter | harmonious, | balance, | fulfillment, a | sweet taste |
| | taste | a little sour | harmonious, | little sweet | lingering |
| | | taste, | drink | | |
| | | watery | fulfillment, | | |

### Example 4

### Effect of Reducing Blood Neutral Fat

Formulation ingredients (unit: g) listed in Table 10 other than a flavor were dissolved in water, and the solution was boiled for one hour and then water corresponding to an evaporated amount of water was added. After cooling, the flavor described in Table 10 was added. Diatomite filtration and filter filtration were performed for clarification. A carbon dioxide gas was then blown into the solution, so that the carbon dioxide gas was dissolved in a gas volume of 2.9. After filling a container with the solution, heat sterilization was conducted so that its internal temperature was 65° C. for 10 minutes or more.

TABLE 10

| | | Experimental plot |
|---|---|---|
| | Control plot 5 | 17 |
| Indigestible dextrin | 0.0 | 14.3 |
| (Fibersol-2) | (0.0) | (15.9) |
| Acesulfame K | 0.03 | 0.03 |
| Soybean protein decomposition | 2.0 | 2.0 |
| product | | |
| Caramel | 0.3 | 0.3 |
| Phosphoric acid | 0.7 | 0.7 |
| Hops | 0.02 | 0.02 |
| Flavor | 2.0 | 2.0 |

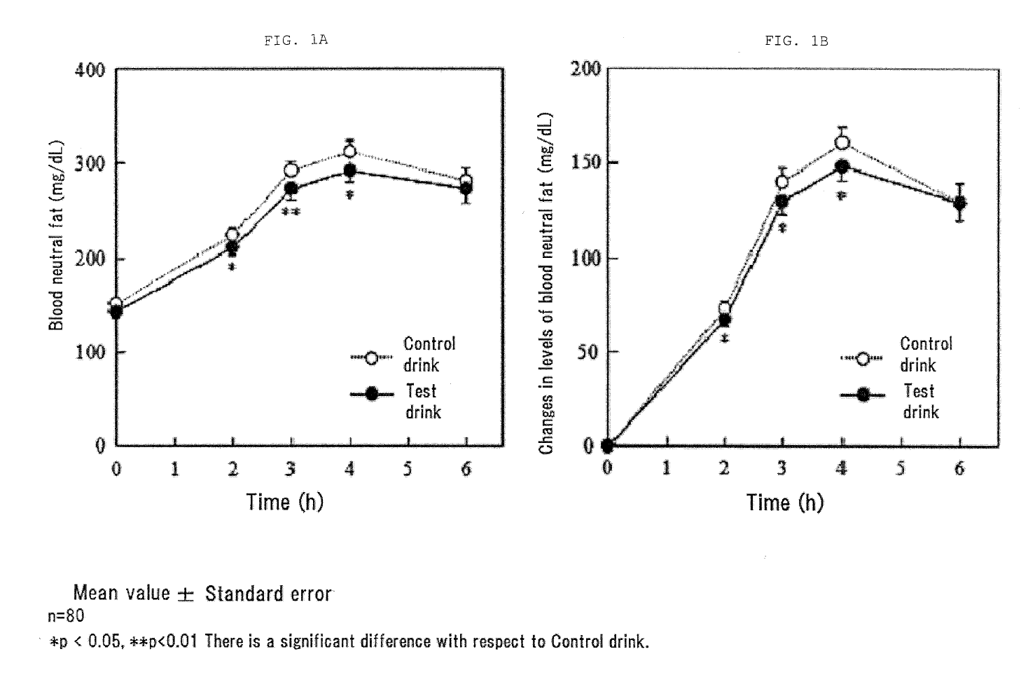

Eighty males and females aged 20 to less than 65 years, whose fasting blood neutral fat levels were slightly higher than the normal high range (120 to 200 mg/dL), served as subjects. A placebo-controlled, randomized double blind crossover study was conducted. The subjects were allowed to take 350 mL of a drink prepared together with a loaded meal containing 42.5 g of lipid. Blood was collected 2, 3, 4, 6 hours after the intake to measure blood neutral fat concentrations. The results are shown in Table 11 and FIG. 1.

TABLE 11

| | Before taking | After 2 hours | After 3 hours | After 4 hours | After 6 hours |
|---|---|---|---|---|---|
| Experimental | 143.2 ± 6.1 | 210.8 ± 8.1* | 272.5 ± 11.0** | 291.5 ± 12.3* | 272.0 ± 14.1 |
| plot 17 | | | | | |
| Control | 151.3 ± 5.7 | 224.4 ± 7.3 | 291.2 ± 10.0 | 311.9 ± 11.7 | 280.4 ± 13.8 |
| plot 5 | | | | | |

Mean value of blood neutral fat concentrations (mg/dL) ± standard error (n = 80)
*p < 0.05
**p < 0.01

In the test results, a test drink-intake group showed a significantly low value compared to a control drink-intake group in blood neutral fat measurements and changes in levels (2, 4 hours after the intake p<0.05, 3 hours after the intake p<0.01). In the present test, no adverse events considered to be attributable to intake of the test drink occurred. These results demonstrate that the carbonated drinks blended with indigestible dextrin, which were used in the present experiment, were safe and useful for suppressing an increase in blood neutral fat after a meal for those whose fasting neutral fat levels are slightly higher than the normal high range.

### Example 5

### Effect by Formulation Amount of Indigestible Dextrin

Formulation ingredients (unit: g) listed in Table 12 other than a flavor were dissolved in water, and the solution was boiled for one hour and then water corresponding to an evaporated amount of water was added. After cooling, the flavor described in Table 12 (the same flavor in both control and Experimental plots) was added. Diatomite filtration and filter filtration were performed for clarification. A carbon dioxide gas was then blown into the solution, so that the carbon dioxide gas was dissolved in a gas volume of 2.9. After filling a container with the solution, heat sterilization was conducted so that its internal temperature was 65° C. for 10 minutes or more.

TABLE 12

| | Control | Experimental | Experimental | Experimental |
|---|---|---|---|---|
| | plot 6 | plot 18 | plot 19 | plot 20 |
| Indigestible | 0.0 | 8.1 | 13.5 | 16.2 |
| dextrin | (0.0) | (9.0) | (15.0) | (18.0) |
| (Fibersol-2) | | | | |
| Acesulfame K | 0.03 | 0.03 | 0.03 | 0.03 |
| Soybean | 2.0 | 2.0 | 2.0 | 2.0 |
| protein | | | | |
| decomposition | | | | |
| product | | | | |
| Caramel | 0.3 | 0.3 | 0.3 | 0.3 |
| Phosphoric | 0.7 | 0.7 | 0.7 | 0.7 |
| acid | | | | |
| Hops | 0.02 | 0.02 | 0.02 | 0.02 |
| Flavor | 2.0 | 2.0 | 2.0 | 2.0 |

Using “CO₂ Hop Extract” (trade name) manufactured by Barth-Haas Group as hops, an adjustment was made so that the iso-α-acids content (g/L) was 0.02 g/L.

The evaluation of the obtained drinks is shown in FIG. 12. For the evaluation, scores on a scale of 9 marked by 6 beer expert panelists, respectively, were averaged. Compared to a control plot containing no indigestible dextrin, it was confirmed that all Experimental plots received higher ratings for “drink fulfillment and stimulation to a throat” and “sharpness after drinking” in accordance with the amount added, without lowering rating for “good balance”. It is considered as follows: By containing indigestible dextrin in the present formulation, drink fulfillment can be imparted to a person without feeling that it is hard to drink due to a thick, sticky poor taste. Thereafter, the contrast of the taste makes the person feel satisfactory sharpness.

TABLE 13

| | Control | Experimental | Experimental | Experimental |
|---|---|---|---|---|
| | plot 6 | plot 18 | plot 19 | plot 20 |
| Drink | 4.8 | 6.0 | 6.8 | 7.3 |
| fulfillment and | | | | |
| stimulation to | | | | |
| a throat | | | | |
| Good balance | 7.0 | 7.0 | 7.2 | 7.2 |
| Satisfactory | 6.2 | 6.5 | 7.0 | 7.0 |
| sharpness | | | | |
| after drinking | | | | |

### Example 6

### Effect by Formulation of Wheat Saccharified Liquid

Formulation ingredients listed in Tables 14 and 15 were mixed, and the mixture was filled with water measured to have a volume of 1 L using a measuring flask. The mixture was boiled for one hour and then water corresponding to an evaporated amount of water was added. Diatomite filtration and filter filtration were performed for clarification. A carbon dioxide gas was then blown into the liquid, so that the carbon dioxide gas was dissolved in a gas volume of 2.9. Saccharified liquid obtained by saccharification reaction of barley malt using a malt derived enzyme, followed by filtration was used (provided that saccharified liquid obtained by saccharifying barley with an enzyme may be used).

TABLE 14

| | Control | | |
|---|---|---|---|
| | plot | Experimental plot 1 | Experimental plot 2 |
| Indigestible dextrin | 12.8 | 12.8 | 12.8 |
| (Fibersol-2) | (14.2) | (14.2) | (14.2) |
| Wheat saccharified | | | |
| liquid | | | |
| Fructose-glucose | | 6 | |
| Acesulfame K | | | 0.025 |
| Soybean protein | 2 | 2 | 2 |
| decomposition | | | |
| product | | | |
| Caramel | 0.3 | 0.3 | 0.3 |
| Phosphoric acid | 0.7 | 0.7 | 0.7 |
| Hops | 0.02 | 0.02 | 0.02 |

TABLE 15

| | Experimental | Experimental | Experimental | Experimental |
|---|---|---|---|---|
| | plot 3 | plot 4 | plot 5 | plot 6 |
| Indigestible | 12.8 | 12.8 | 12.8 | 12.8 |
| dextrin | (14.2) | (14.2) | (14.2) | (14.2) |
| (Fibersol-2) | | | | |
| Wheat | 33.3 | 100 | 33.3 | 33.3 |
| saccharified | | | | |
| liquid | | | | |
| Fructose- | | | 4 | |
| glucose | | | | |
| Acesulfame K | | | | 0.018 |
| Soybean | 2 | 2 | 2 | 2 |
| protein | | | | |
| decomposition | | | | |
| product | | | | |
| Caramel | 0.3 | 0.3 | 0.3 | 0.3 |
| Phosphoric | 0.7 | 0.7 | 0.7 | 0.7 |
| acid | | | | |
| Hops (iso-α- | 0.02 | 0.02 | 0.02 | 0.02 |
| acids) | | | | |

The wheat saccharified liquid having an extract content after filtration (a non-volatile component) of 15 wt % was added in designated amounts (the wheat saccharified liquid was added so that the final extract contents were 0.5 wt %, and 1.5 wt %). Using “CO₂ Hop Extract” (trade name) manufactured by Barth-Haas Group as hops, an adjustment was made so that the final iso-α-acids content was 0.02 g/L.

The evaluation of the obtained drinks was shown in Tables 16 and 17. For the evaluation, scores on a scale of marked by 3 beer expert panelists, respectively, were averaged. A sensory evaluation was conducted with a nose clip attached to the nose in order to avoid influences by an aroma. Compared to a control plot, it was confirmed that Experimental plots received higher ratings for “good balance” and “satisfactory sharpness after drinking” with a monosaccharide, disaccharides and acesulfame K of Experimental plots. Also, the energies of samples using these low-molecular-weight saccharides and sweeteners were checked. Those samples using the sweeteners including acesulfame K had a very low amount of energy, so that it was confirmed that these formulations could reduce energy intake of those who were concerned with obesity and metabolic syndrome.

TABLE 16

| | | Experimental | Experimental |
|---|---|---|---|
| | Control plot | plot 1 | plot 2 |
| Good balance | 5 | 7.7 | 7 |
| Satisfactory | 5.7 | 7.3 | 6.7 |
| sharpness after | | | |
| drinking | | | |
| Comments | Sour taste, a | Good balance, | Satisfactory |
| | remaining bitter | satisfactory | sharpness, a little |
| | taste, watery, | sharpness, | sour taste, a little |
| | poor balance, | harmonious, mild | watery, good |
| | bitter taste in | | balance |
| | the latter half | | |
| Energy | 3.0 kcal/100 mL | 5.4 kcal/100 mL | 3.0 kcal/100 mL |

TABLE 17

| | Experimental | Experimental | Experimental | Experimental |
|---|---|---|---|---|
| | plot 3 | plot 4 | plot 5 | plot 6 |
| Good balance | 5 | 5.3 | 6.3 | 6 |
| Satisfactory | 5.3 | 4.7 | 5.7 | 5.7 |
| sharpness | | | | |
| after drinking | | | | |
| Comments | A little smell of | Smell of wort, | A little smell of | A little smell of |
| | wort, sour | smell of sweet | wort, mild, a | wort, sweet |
| | taste, a | potatoes, | little sour | taste in the |
| | remaining | heavy, | taste, | first half, a |
| | bitter taste, a | astringent | powdered | remaining |
| | little sticky, | taste, | | bitter taste, |
| | powdered | powdered | | powdered |
| Energy | 5.0 kcal/100 mL | 9.0 kcal/100 mL | 6.6 kcal/100 mL | 5.0 kcal/100 mL |

1. A non-fermented beer taste drink, which contains indigestible dextrin at a concentration of 8 g/L or more, and a bitter-taste substance.

2. The non-fermented beer taste drink according to claim 1, wherein the bitter-taste substances are iso-α-acids.

3. The non-fermented beer taste drink according to claim 2, which has a concentration of the iso-α-acids of 0.001 g/L or more.

4. The non-fermented beer taste drink according to claim 1, which was produced without using wort or a barley extract.

5. The non-fermented beer taste drink according to claim 1, which further contains a sweet-taste substance.

6. The non-fermented beer taste drink according to claim 5, which has a concentration of the sweet-taste substance of 18 g/L or less in sucrose equivalent.

7. The non-fermented beer taste drink according to claim 5, wherein the sweet-taste substance is acesulfame K, and its concentration is 0.09 g/L or less.

8. The non-fermented beer taste drink according to claim 5, wherein the sweet-taste substance is at least one saccharide selected from the group consisting of a monosaccharide, a disaccharide, and a trisaccharide.

9. The non-fermented beer taste drink according to claim 1, which has an effect of reducing blood neutral fat by drinking.
